(19) United States
(12) Patent Application Publication
(10) Pub. No.: US 2025/0222841 A1
(43) Pub. Date: Jul. 10, 2025

(54) WEATHER RESISTANT AIR FLOW DISTRIBUTION SYSTEM FOR SEATS

(71) Applicant: Charles J Cauchy, Traverse City, MI (US)

(72) Inventor: Charles J Cauchy, Traverse City, MI (US)

(21) Appl. No.: 18/705,379

(22) PCT Filed: Oct. 28, 2022
(86) PCT No.: PCT/US2022/048234

§ 371 Date: Apr. 26, 2024

Related U.S. Application Data
(60) Provisional application No. 63/272,972, filed on Oct. 28, 2021.

(51) Int. Cl. B60N 2/56

(52) U.S. Cl. CPC B60N 2/5642

(57) ABSTRACT

A weather resistant seating ventilation system is disclosed that overcomes the barrier of using a perforated ventilated solution for the cooling and heating of seat occupants in outdoor environments by preventing the entry of water or other foreign material. The invention incorporates a small, high flowrate, high pressure blower to force air through openings in the seat surface. Prior to and directly adjacent to the seat surface, a one-way valve is used to allow heated or cooled air to flow toward the seat occupant but not allow liquids to flow into the perforations in the seat.

### CROSS-REFERENCE TO RELATED APPLICATIONS

This application claims the benefit under 35 U.S.C. 119 (e) of U.S. Provisional Application 63/272,972, filed Oct. 28, 2021.

### FEDERALLY SPONSORED RESEARCH AND DEVELOPMENT JOINT RESEARCH AGREEMENT

Not Applicable

### REFERENCE TO A “SEQUENCE LISTING”, A TABLE, OR A COMPUTER PROGRAM LISTING APPENDIX SUBMITTED ON A COMPACT DISC AND AN INCORPORATION-BY-REFERENCE OF THE MATERIAL ON THE COMPACT DISC Not Applicable

### PRIOR ART

Not Applicable

### BACKGROUND OF THE INVENTION

### 1. Field of the Invention

The present invention relates to a new weather resistant vehicle seat, and more particularly, the invention relates to a weather resistant air flow distribution system for heated and cooled seats that will not be harmed when rained upon.

### 2. Description of the Prior Art

Clearly, conventional outdoor exposed vehicle seats for motorcycles and the like that are exposed to the outer elements get wet in the rain. Full coverage waterproof materials have been promoted to solve the problem of rain saturated seat materials. However, now that vehicle operators have become accustomed to heated and cooled car seats, they want heated and cooled seats for their other vehicles, like agricultural vehicles, motorcycles, golf carts, marine applications and boats, along with other types of vehicles where their seat is exposed to rain and snow.

However, heated and cooled seats are covered with materials that are generally perforated to allow for contacting warmed and cooled air to the occupant. It is common sense that those perforations in the seat material would let rain or snow to flow into the underlying seat material and components. That exposure to rain would obviously cause problems with heating and cooling components, especially their electrical wiring and motors.

Therefore, it would be an advantage to the industry if a heated and cooled seat could comfort an occupant even after being exposed to the outer elements. This is the problem that the present invention addresses.

### SUMMARY OF THE INVENTION

In accordance with the above-noted advantages and desires of the industry, the present invention provides a weather resistant air flow distribution and seating ventilation system that overcomes the barrier of using a ventilated solution for the cooling and heating of seat occupants in outdoor environments or those environments that experience exposure to the outer elements with the presence of water or other foreign liquids. The invention is also less expensive to manufacture and much simpler to install into a seat than other thermoelectric based systems that heat and cool.

In most of the aspects of the present invention, the invention incorporates a small, high flowrate, high pressure blower to force air through openings in the seat surface. Prior to and directly adjacent to the seat surface, a one-way valve is used to allow air to flow toward the seat occupant but not allow liquids to flow back in from the environment. This one-way valve allows passage of air from the blower, through ducting or tubing in the seat cushion and then to the seat surface with low pressure drop on the blower to maximize air flow to the seat occupant. The valve is spring loaded and blocks the flow of liquid or other foreign material into the air distribution system when the blower is not in operation. In addition, the air exit at the seat surface can be covered in a hydrophilic mesh that allows passage of cooling air but resists water. In addition, a P-shaped water trap can be added at the bottom of the air sweep that brings the air to the final exit point on the seat.

At the seat surface, the exit openings can be used alone or with the hydrophilic mesh. An added expanded mesh material, sometimes called 3D spacer mesh can be used to cover the air openings so as to provide a dispersed air flow medium under the seat occupant which also prevents the possible blocking of the air openings by leather pants or the like. An alternative aspect to ensure the air flow to the seat occupant is not blocked or impaired, is the use of air passageways molded or impressed into or onto the seat cover. Heating can be added to the system with the addition of a low cost resistance heater element placed in the air flow stream.

To improve the evaporative performance of the flowing air over the seat occupant's skin and aiding cooling, a desiccant canister can be added to the system air flow stream to provide desiccated air to the seat occupant. Two or more desiccant canisters can be used in combination with air diverter valves to allow for the recharging of one canister while the other canister is in use.

Another aspect of the invention is using a thermoelectric cooling and heating assembly inline with the air stream to cool or heat the air prior to distribution to the seat surface. In this aspect, the air that is drawn into blower flows through a heat sink that is being cooled or heated by a thermoelectric device. This thermally conditioned air exits the heat sink and is then distributed to the surface of the seat or other body contact item. Systems exist using this same concept but not for distribution in a water resistant system designed to be used in outdoor environments. The existing systems are open air systems that allow water or other fluids to infiltrate through the seat cover and into the working of the seat cooling/heating system. The different construction options can be used together or separately.

In harsh environments, such as motorcycle seating or off-road vehicle seating, splashing and submersion in water is possible. Though the ingress of water and water borne debris is prevented from entering the seat occupant portion of the system via the one-way valves and hydrophilic mesh, it is still possible, during splash or immersion events, water could enter the fan intake.

Two aspects of the invention block the above noted ingress of water, or other contaminants. The first is a splash guard that allows for airflow to the blower intake but deflects splash. The other is a float valve mechanism that blocks ingress with the ‘floating’ of a low density member into a sealing position of the blower intake.

Other applications for the present invention may include other uses such as pet beds, stadium seating, medical bedding requiring wash down, improved automotive seating, bicycle seats, construction & agricultural seats, beds, chairs, whether home or office, sofas, operating tables, and even small animal enclosures, etc. Because these applications are exposed to rain, wash water, splashing and the like, it is a real advantage to provide a weather and liquid resistant covering for electronics and machinery under the outermost material.

Controlling body heat in individuals is important in maintaining optimum body performance and comfort. In recognition of this, many homes, offices, workplaces, automobiles, etc. are conditioned to maintain a certain temperature with heating, cooling and ventilation systems. In automotive settings, heated seats, cooled seats and ventilated seats are commonly available. These systems provide heating and cooling to seat occupants providing a comfortable seated experience.

The most common of the heating systems for seating are electrical resistance mats for heating. These systems are relatively inexpensive and have been used for many years. The heated mats use thermal conduction to move the heat energy they produce to the occupant.

Combined heating and cooling systems often use a thermoelectric device to pump heat to a thermal delivery heatsink for heating a seat occupant or cooling a thermal delivery heat sink for cooling a seat occupant. Most such systems rely on the cooling or heating of air that is then distributed to the seat occupant via perforations in the seat.

Another system using a thermoelectric device is similar to those using air as the thermal distribution medium, instead uses a conductive material to transport the heat to or from the seat occupant. This conductive material lies beneath the seat surface and conducts heat or coolness the seat occupant.

One of the most common systems in automobiles to aid in the cooling of people sitting in seats, is to force air through perforations in seats. This moving air is like a breeze that aids in evaporating skin moisture, which, in turn, cools the body. This system is less costly than thermoelectric device based systems because it consists primarily of a fan or blower and ducts that provide air to the perforations in a seat.

For cooling seat occupants, the systems previously noted can work rather well. These systems, are, however expensive and difficult to package in the small amount of space associated with seats. In the case of the systems using perforations, water, beverages, dirt and dust can infiltrate the holes, causing obstructions in the small diameter perforations, and allowing fluids to get into the seat structure providing an environment for the possible growth of biological organisms. These perforated systems cannot be used in outdoor environments where water and other foreign materials can infiltrate the porous layers of the system. Along with the potential for biological growth should water or other liquid or muddy material enter the seat via the perforations, in some environments, water could infiltrate the system and cause damage to components such as blowers or thermoelectric devices. This is why motorcycle seats, off-road vehicle seats, heavy equipment seats, farm tractor seats, boat seats, etc., do not use perforated or ventilated seats.

Although the invention will be described by way of examples hereinbelow for specific aspects having certain features, it must also be realized that minor modifications that do not require undo experimentation on the part of the practitioner are covered within the scope and breadth of this invention. Additional advantages and other novel features of the present invention will be set forth in the description that follows and in particular will be apparent to those skilled in the art upon examination or may be learned within the practice of the invention. Therefore, the invention is capable of many other different aspects and its details are capable of modifications of various aspects which will be obvious to those of ordinary skill in the art all without departing from the spirit of the present invention. Accordingly, the rest of the description will be regarded as illustrative rather than restrictive.

### BRIEF DESCRIPTION OF DRAWINGS

For a further understanding of the nature and advantages of the expected scope and various aspects of the present invention, reference shall be made to the following detailed description, and when taken in conjunction with the accompanying drawings, in which like parts are given the same reference numerals, and wherein:

FIG. 1 is a side perspective view of a motorcycle seat, with the air distribution system being made in accordance with the present invention;

FIG. 2 illustrates an off the road vehicle seat with three-dimensional mesh ovals; FIG. 3 is a detailed illustration of the three dimensional mesh;

FIG. 4 illustrates an off the road vehicle seat with air flow passages;

FIG. 5A is a side elevational view of an airflow passage cut in;

FIG. 5B is a side elevational view of an airflow passage proud of the surface;

FIG. 6 shows a top plan view of an air distribution system in series;

FIG. 7 shows a top plan view of an air distribution system in parallel;

FIG. 8 is a side elevational view of the air distribution system utilizing bellows;

FIG. 9 shows another aspect of the present invention with a blower motor and tubular air distribution system;

FIG. 10 is a side perspective view of a weather resistant one way valve;

FIG. 11 is a front elevational view of a seat with the one-way valve extending through covered by a hydrophobic mesh;

FIG. 12 is a side elevational cross-section of the one-way valve covered by a hydrophobic mesh;

FIG. 13 a bottom plan view of an aspect of the present invention showing the human interface for the controller;

FIG. 14 is another view of the blower, human controller interface and the controller;

FIG. 15 shows a system electronic controller;

FIG. 16 shows a seat bottom with a seat pan;

FIG. 17A illustrates an air heater;

FIG. 17B is a plan, or cross sectional view of the air heater shown in FIG. 17A;

FIG. 18 shows a top view of and in-line air heater system;

FIG. 19A illustrates air desiccant cartridge in line;

FIG. 19B is a cross-sectional view of the air desiccant cartridge of FIG. 19A;

FIG. 20 is a top view of a rechargeable air desiccant system;

FIG. 21A is a side elevational view of a thermoelectric cooling system;

FIG. 21B is a side elevational view of a thermoelectric heating system;

FIG. 22 is a perspective view of a thermoelectric heat sink module;

FIG. 23 shows the layout of the thermoelectric heating and cooling system with a blower;

FIG. 24 shows a splash guard for repelling water; and

FIG. 25 illustrates an underwater protection float valve.

FIG. 26 shows a side elevational view of a seat foam incorporating an air distribution system;

FIG. 27 illustrates a side elevational view of an aftermarket heated/cooled seat pad made in accordance with the present invention; and

FIG. 28 shows yet another aspect of the invention showing air flow.

### DETAILED DESCRIPTION OF THE INVENTION

In accordance with the present invention, a weather resistant heating and cooling system is disclosed for incorporation into a perforated surface, especially useful for heated and/or cooled seats and/or ventilated seats that are desiccated that are used in motorcycles, golf carts, snowmobiles, all terrain vehicles (ATV's), boats, and any other seating type of application. As one can imagine, such seating applications are usually exposed to the outer elements, including rain and/or snow, and since perforated leather or its synthetic counterpoint are generally prescribed to allow the heated, cooled, or desiccated air to come up through the seat to comfort a passenger, it is necessary to essentially waterproof the seat. In that regard, the present invention provides a means for making a perforated seat to be weather resistant enough so as to functionally waterproof the seat, or any other application requiring weather or water resistance. The most common of the heating systems for seating are electrical resistance mats. These systems are relatively inexpensive and have been used for many years. The heated mats use thermal conduction to move the heat energy they produce to the occupant.

Combined heating and cooling systems often use a thermoelectric device to pump heat to a thermal delivery heatsink for heating a seat occupant or to cool with the use of a thermal delivery heat sink for cooling the seat occupant. Most of these systems rely on the cooling or heating of air that is then distributed to the seat occupant via perforations in the seat.

Another aspect includes using a thermoelectric device similar to those using air as the thermal distribution medium, but instead uses a conductive material to transport the heat to or from the seat occupant. This conductive material lies beneath the seat surface and conducts heat/cool to or from the seat occupant.

One of the most common systems in automobiles to aid in the cooling of people sitting in seats, is to force air through perforations in seats. This moving air is like a breeze that aids in evaporating skin moisture, which, in turn, cools the body. This system is less costly than thermoelectric device based systems because it consists primarily of a fan or blower and ducts that provide air to the perforations in a seat.

For cooling seat occupants, the systems previously noted can work rather well. These systems, are, however expensive and difficult to package in the small amount of space associated with seats. In the case of the systems using perforations, water, beverages, dirt and dust can infiltrate the holes, causing obstructions in the small diameter perforations, and allowing fluids to get into the seat structure providing an environment for the possible growth of biological organisms.

These perforated systems cannot be used in outdoor environments where water and other foreign materials can infiltrate the porous layers of the system. Along with the potential for biological growth should water or other liquid or muddy material enter the seat via the perforations, in some environments, water could infiltrate the system and cause damage to components such as blowers or thermoelectric devices. This is why motorcycle seats, off-road vehicle seats, heavy equipment seats, farm tractor seats, boat seats, etc., do not use perforated or ventilated seats.

In order to control these functions in the abovementioned aspects, it will be useful to incorporate various controls. Such controls may include a direct ON/OFF electrical switch; a pulse width modulated control (PWM) for blower, heater and thermoelectric device; and a microprocessor logic control+PWM to speed or slow blower based on preset operational parameters.

A controller finds great utility in order to allow more or less electrical energy for powering the resistance heating device based on preset parameters as well as to allow for controlling heating or cooling by changing the polarity of the thermoelectric device and adjusting the amount of electrical energy to the device. An example of this operation entails the sensing of the outside temperature and adjusting blower, blower plus heater, or blower plus thermoelectric device, to keep the seat occupant comfortable based on set operational parameters loaded into the microprocessor. Further, temperature control may be accomplished by the use of a thermistor placed at the air outlet, or somewhere within the outlet air flow duct of the heater or on the heater. Other aspects include using a thermistor placed at the outlet or somewhere within the outlet air flow duct of the thermoelectrically heated or cooled heat sink or on the heat sink. Yet another aspect includes a temperature sensing device, such as a thermistor, which can be placed near the seat surface. This is primarily used to monitor the temperature so as to not allow the temperature to exceed a set temperature for the safety of the seat occupant.

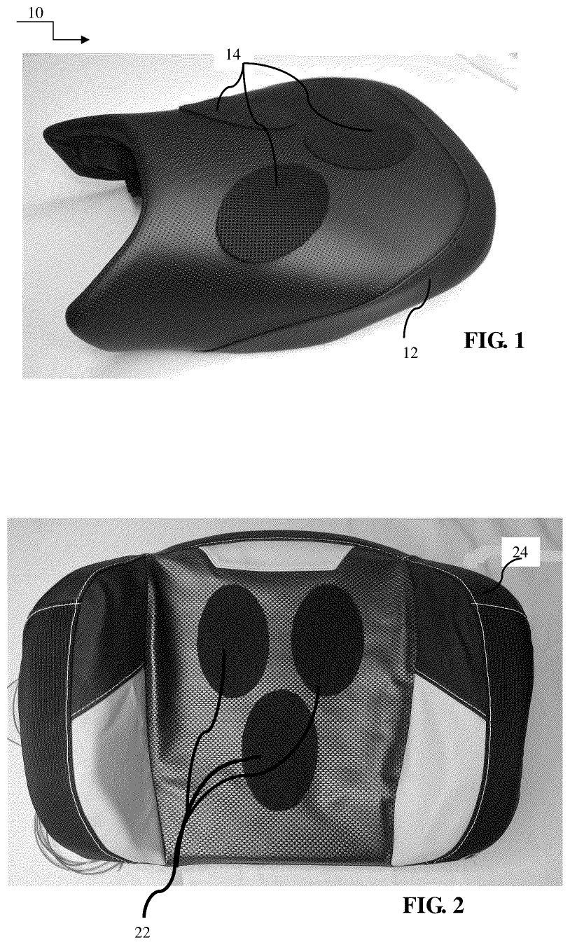

Referring now to the drawings in detail, FIG. 1 is a perspective view of a motorcycle seat generally indicated by the numeral 10, which also includes at least one layer of perforated seating material 12. Individual patches 14 made of a three-dimensional mesh type fabric render those areas of seat 10 as air distributors.

Looking next to FIG. 2, there is shown an off-road vehicle seat with individual 3-D mesh patches 22 attached to the seat cover of seat 24.

FIG. 3 shows a close-up view of a preferred 3-D mesh material patch 32 that allows for air distribution under a seat occupant so as to prevent the seat occupant from restricting air flow, which can occur if the seat occupant is wearing thin, tight fitting clothing. The seat will still provide some air flow without the 3-D mesh, but the performance is improved with the mesh. If the mesh is wet from precipitation, the mesh dries very quickly and provides an extra cooling effect due to evaporative cooling. The mesh shown is 3 mm thick but can be thinner or thicker. The mesh can be adhered to the seat cover or sewn onto the seat cover.

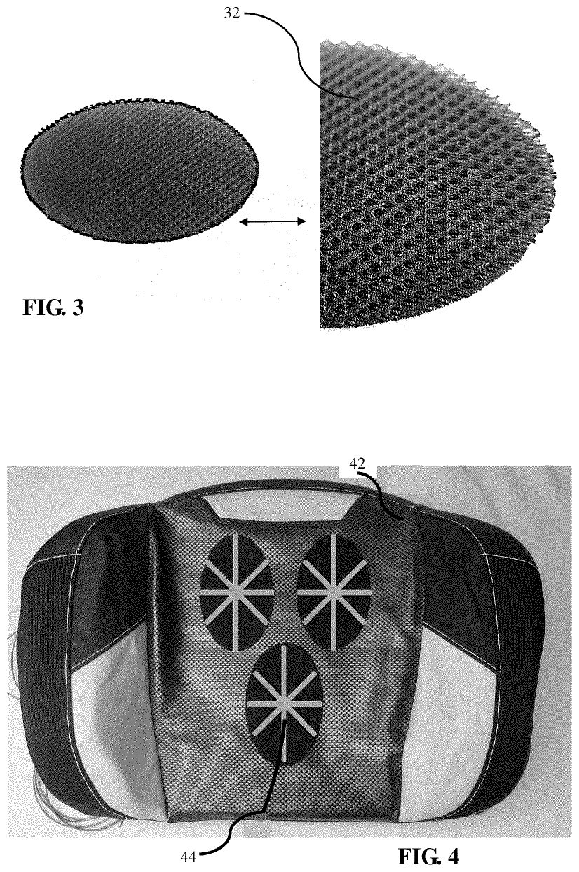

FIG. 4 illustrates seat cover 42 having air flow passages 44 that allows for air distribution under the seat occupant, so as to prevent the seat occupant from restricting air flow which can occur, especially if the seat occupant is wearing thin, tight fitting clothing. The seat will still provide some air flow without the air flow passages but the performance is improved with the air flow passages. This aspect serves much the same purpose as the 3-D mesh described in detail hereinabove. The air flow passages are molded into the seat cover. They can be present below the seat cover plane or above the seat cover plane which is proud of the seat cover. Though the drawing shows a star configuration, different patterns can be used.

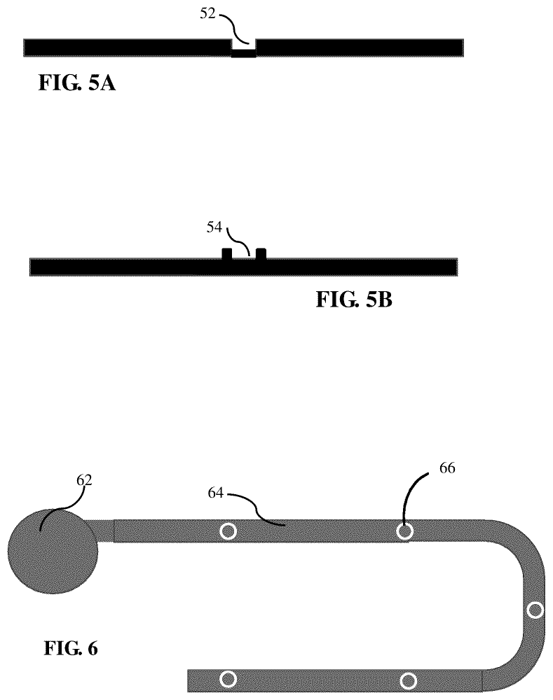

FIG. 5: Similar to the aspect shown in FIG. 4, this aspect shows air flow passage detail. The drawing shows air flow passages molded into the seat cover 52 and molded or formed or adhered above the seat cover plane 54.

FIG. 6 shows a top view of an air flow distribution system where air is drawn into blower 62, and forced through ducting or tubing 64 within or exterior to a seat. Air passes through seat padding, often a polyurethane seating foam, up from the main distribution line(s) 64 to the surface of the seat. The number of distribution lines 66 to the seat surface can vary in number. This figure shows a series flow pattern.

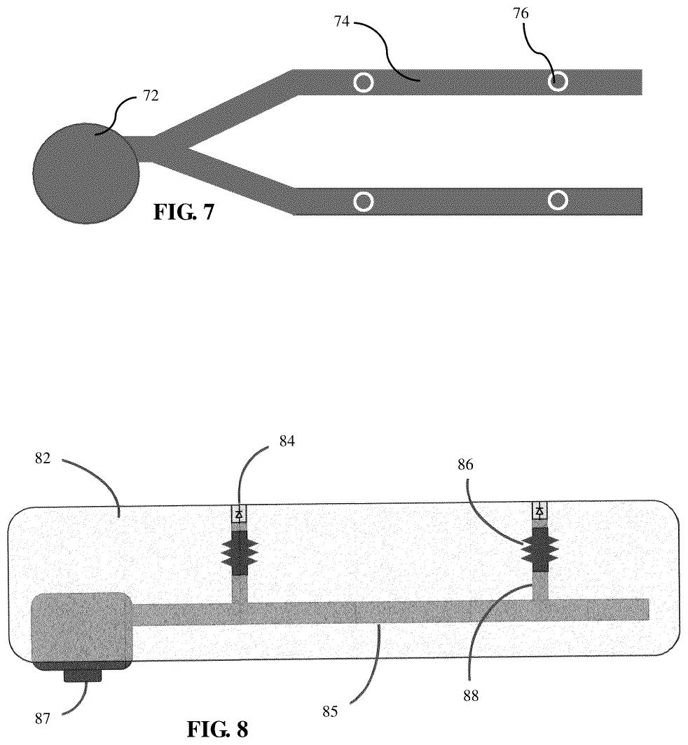

Looking next to FIG. 7, an air flow distribution system top view is shown similar to FIG. 6, but showing a parallel air flow pattern. Blower 72, air distribution ducting or tubing 74 and air outlet lines (ducts or tubes) 76 are components for moving the heated or cooled air around under the seat so that it may comfort a passenger.

FIG. 8 illustrates yet another aspect of the present invention showing an air flow distribution system including a blower 87, an air distribution tubing 85 that could be ducts molded into foam seat bun 82, and a one way valve 84 to allow the passage of air to the seat surface. However, by using a one way valve, it stops liquid flow such as water from rain, washing, etc. from entering the air distribution system. Bellows 86 allows air that is exiting tubing 88 to contract and expand with bouncing motion of rider to prevent feeling the tube during seat compression. This is not required on all seats, depending on seat design. The bellows is preferably rubber, thermoplastic elastomer or any other suitable flexible material.

FIG. 9 shows yet another aspect with an air flow distribution system in the seat bottom. For clarity, this system is shown prior to installation in the seat foam bun. In completing the system, shown are blower 98, air distribution tube 94, seat cushion foam bun 96 and air exit tubing 92.

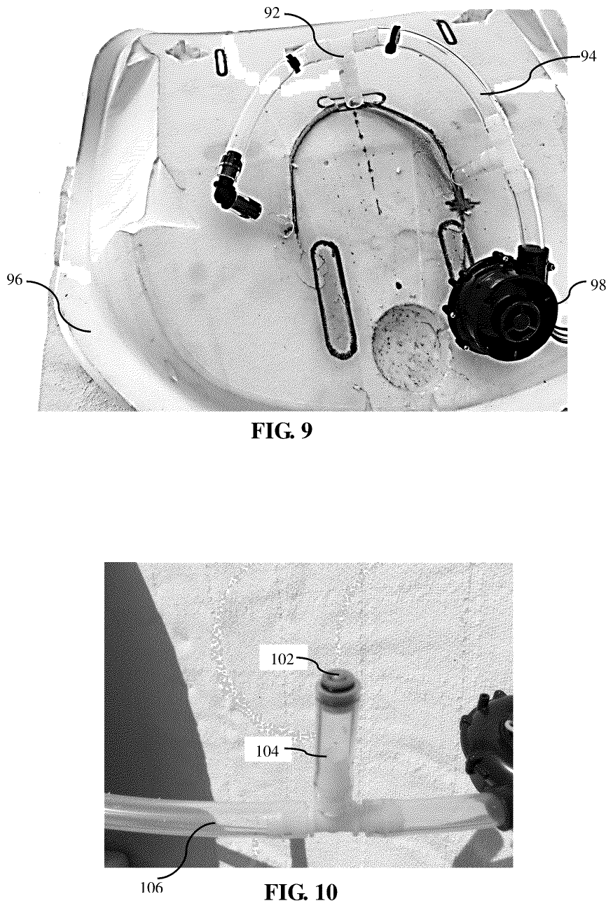

FIG. 10 is a close-up view of a preferred one way valve 102 on the seat surface end of air distribution exit line 104. One way valve 102 is internal to the air exit distribution line, and as can be seen, the air exit distribution line (tube) is connected to the main air distribution line (tube or duct) 106.

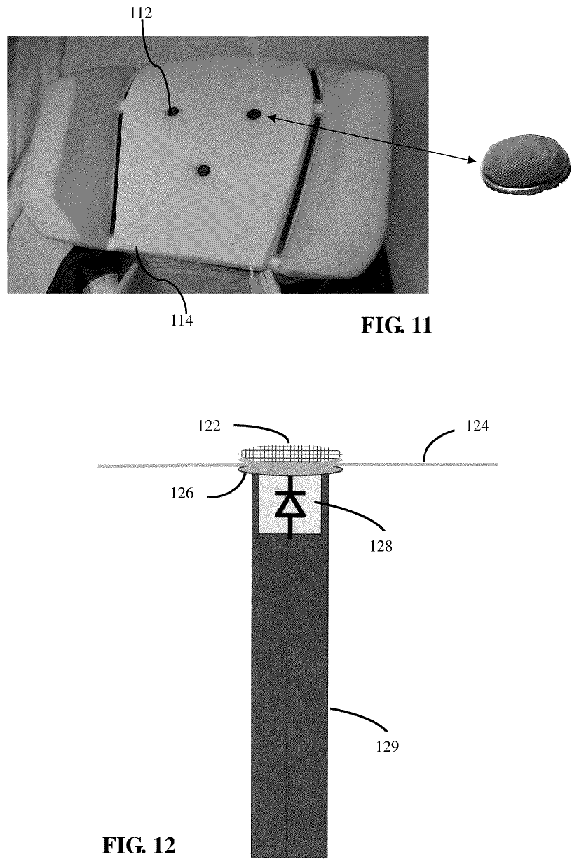

FIG. 11 shows yet another preferred aspect of the present invention for preventing water from entering the seat by utilizing a cap 112 of hydrophobic fabric at the air distribution surface terminus of the seat with an air exit distribution end that exits the seat. A hydrophobic covering on tube end 112 and seat 114). The hydrophobic fabric provides an extra protection that prohibits water or other foreign material from entering the seat distribution system. It also provides a visual black surface that obscures the air flow outlet. The hydrophobic fabric may or may not be used in combination with the one way valve and vice versa.

FIG. 12 illustrates a side elevational cutaway view of a watertight seat surface air distribution terminus, wherein the air distribution exit tube 129, the one way valve 128, hydrophilic fabric 122 and a joining member 126 secures the parts to the seat cover 124. The joining member is attached to the outside of the tube terminus and secures the seat covering and the hydrophilic fabric. This part may be made of rubber, but any other suitable material can be used.

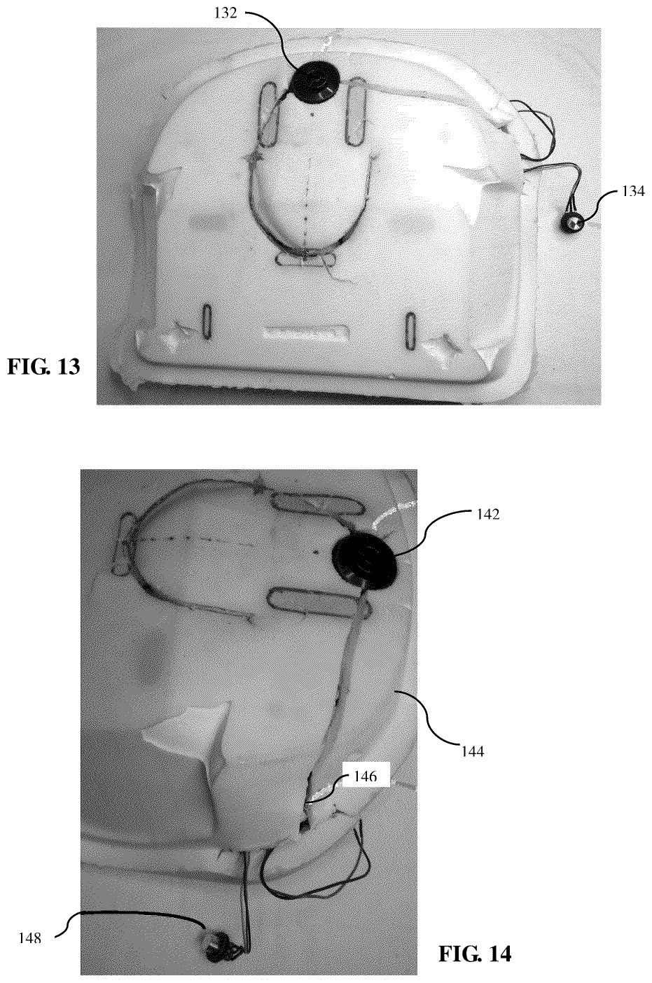

Referring next to FIG. 13, a system packaged within a conventional seat foam is shown as the underside of its seat cushion foam with the system installed therein. Consequently, the system can be fully enveloped within a seat foam. The components that are visible are the blower 132 and the electric power control dial 134.

FIG. 14 details a System electronic controller 146 hidden within the body of a seat foam. Shown is the underside view of a foam seat cushion 144 with the pulsed width modulation electronic controller embedded within the foam seat cushion. It also shows the power control dial 148. The control input can be a dial, as shown, or any other suitable occupant electronic signal input device such as a momentary switch or wireless signal input. Blower 142 is also shown.

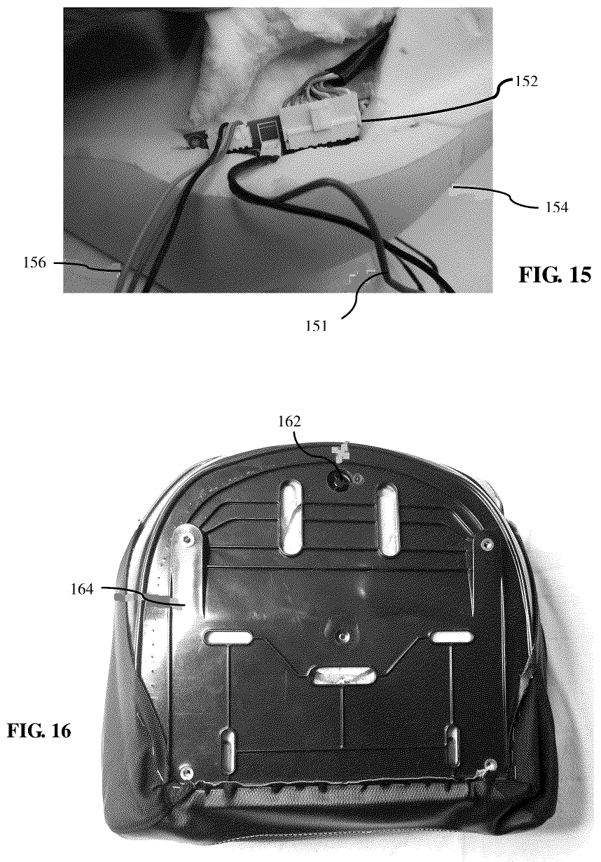

Meanwhile, for clarity, FIG. 15 shows system electronic controller 152 prior to insertion in body of foam seat cushion 154. Relative connectivity of electric power wires 151 and control wires 156 are illustrated.

Moving on to FIG. 16, a seat bottom with seat pan 164 with blower intake 162 is shown from underneath. Not all seats are constructed with plastic seat pans for seat structure. Some seats use mesh suspension, metal wire suspension, fiberglass, wood seat base, etc. The weather resistant heated and cooled seating system made in accordance with the present invention is compatible with most seat types.

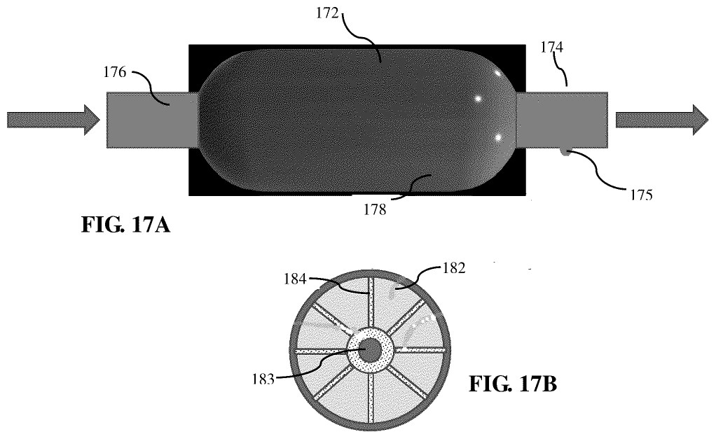

With collective reference to FIGS. 17A and 17B, there is described yet another aspect of the present invention wherein an auxiliary air heater is disclosed. To add actively created heat to the previously described seat ventilation system, another system aspect is shown. An electric cartridge heater 183 is affixed into an annular opening in a heat sink 184, which is inside a tube 178 that is part of the air distribution system. When warm air is desired by the seat occupant, the occupant switches on an enclosed heater rod and air flows over the heat sink. Said heat sink is most likely an aluminum extrusion, but could be other material. Heated air 182 is then distributed to the seat surface. A thermistor temperature sensor 175 is used to monitor outlet air temperature. Although the preferred heat sink fin design is shown, any other suitable design can be different than what is shown. The drawing also shows the air inlet 176 and air exit 174.

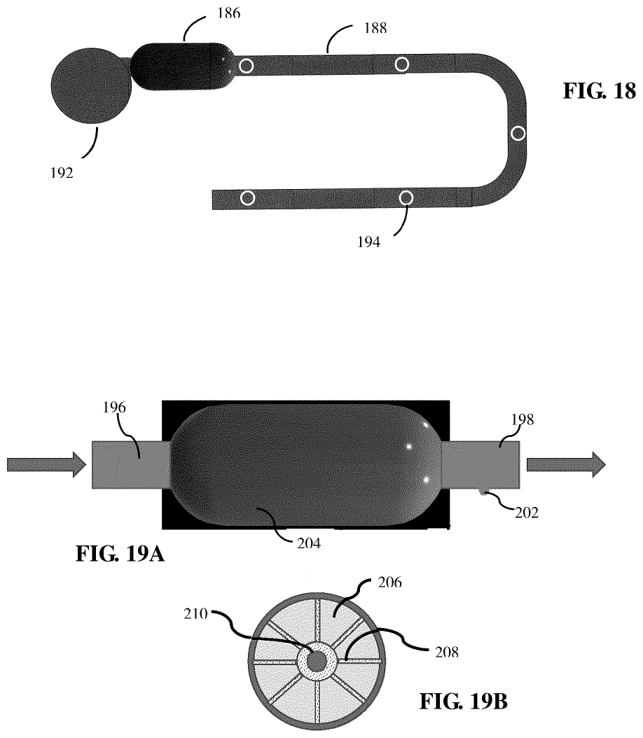

FIG. 18 shows a top view of a drawing of an inline air heater in the system. Air is drawn into blower 192, and forced through the air heater 186. Alternatively, if the air heater is at a greater distance, air distribution ducting or tubing 188 is in thermal communication with the air heater. If the air heater is powered, heated air then flows through the air distribution system tubing or ducting, then through the air distribution exit tube 194, and finally up to the surface of the seat. The number of exit air lines to the seat surface can vary in number. This figure shows a series flow pattern.

In yet another aspect of the present invention, FIG. 19 discloses the use of an air desiccant cartridge to be connected inline. The desiccant cartridge has much the same structure as the air heater. Addition of desiccant 206 allows for air passing through the cartridge to be lowered in humidity, providing greater comfort to the seat occupant due to more skin moisture, such as sweat usually, to be evaporated from the body. When the cartridge is saturated with moisture, the heater cartridge can be activated, heating the desiccant, driving the collected moisture from the desiccant. Once dried, the cartridge can be used again to dehumidify air prior to distribution to the seat surface. An electric cartridge heater 210 may be affixed into an annular opening in a heat sink 208, which is inside a tube 204 that is part of the air distribution system. When the blower is activated, air flows into the cartridge inlet 196, through the desiccant, and out into the air distribution duct or tube to the seat occupant. To recharge the desiccant, the desiccant is heated by the heat sink, and air flowing through the desiccant chamber, while the desiccant is giving off water vapor, carries the moisture out of the desiccant cartridge. The heat sink fin design can be different than what is shown. The drawing also shows the cartridge air exit 198 and a humidity and temperature sensor 202.

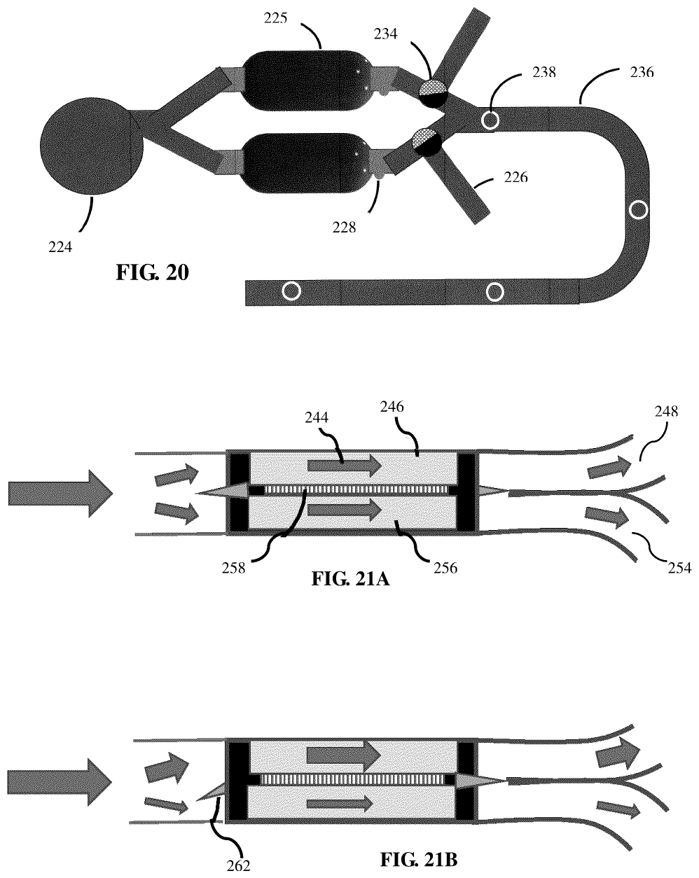

Now looking at FIG. 20, an air desiccant cartridge aspect is illustrated in a system aspect where the desiccant cartridges 225 can be alternated between capturing moisture in the air going to the seat occupant and being recharged by driving moisture from the desiccant. The diverter valves 234, indicate that while one unit is drying air for seat system use, the other cartridge can be recharged by heating the desiccant and expelling the moisture laden air to the ambient environment. The cartridge being used in occupant cooling has a greater airflow than the recharging desiccant cartridge. Air drawn into blower 224 is forced through a desiccant cartridge. Desiccated air flows through the air distribution system tubing or ducting 236, then through the air distribution exit tube 238, to the surface of the seat. When one of the cartridges is saturated with water, a humidity/temperature sensor 228 sends a signal to the controller to activate the diverter valves to direct occupant cooling air to the cartridge able to take moisture out of the flowing air. The diverter valves also direct airflow through the saturated cartridge and the heater is activated. Moisture laden air exiting from the recharging cartridge is exited through discharge tube 226. The number of exit air lines to the seat surface can vary in number. This figure shows a series flow pattern for air distribution to the air distribution exit tubes. If heating is desired by the seat occupant, one or both of the cartridges can be used as an air heater.

With combined reference to FIG. 21A & 21B, another aspect of the present invention is disclosed that utilizes thermoelectric heating and cooling components to achieve either a heated or a cooled aspect. This additional aspect of the system allows for both heating and cooling of the air prior to distribution to the seat surface. When cooling is desired, the thermoelectric device 258 cools the top heat sink 246 and air from the blower 244 passes through the cooled heat sink, cooling the air that is distributed 248 to the seat surface. When heating is desired, the polarity of the electric energy is reversed, and the top heat sink is heated. Air passing through the heat sink is heated prior to distribution through the system and to the seat surface. During the cooling mode, the heat that is pumped by the thermoelectric device is moved to the lower heat sink 256 and is exited to the ambient environment 254. In heating mode, the lower heat sink may or may not have air passed through it depending on system requirements and the ambient temperature. Further, in FIG. 21B, an air modulating valve 262 can be used to reduce or increase air flow through the heat sinks. In some aspects of the invention, proper design of the system for pressure drop will negate the need for a modulating valve. The thermoelectric device will commonly us 12-16 VDC electric power. A pulse width modulated controller can be used to control the amount of electrical energy being supplied to the thermoelectric device, regulating the amount of cooling or heating desired.

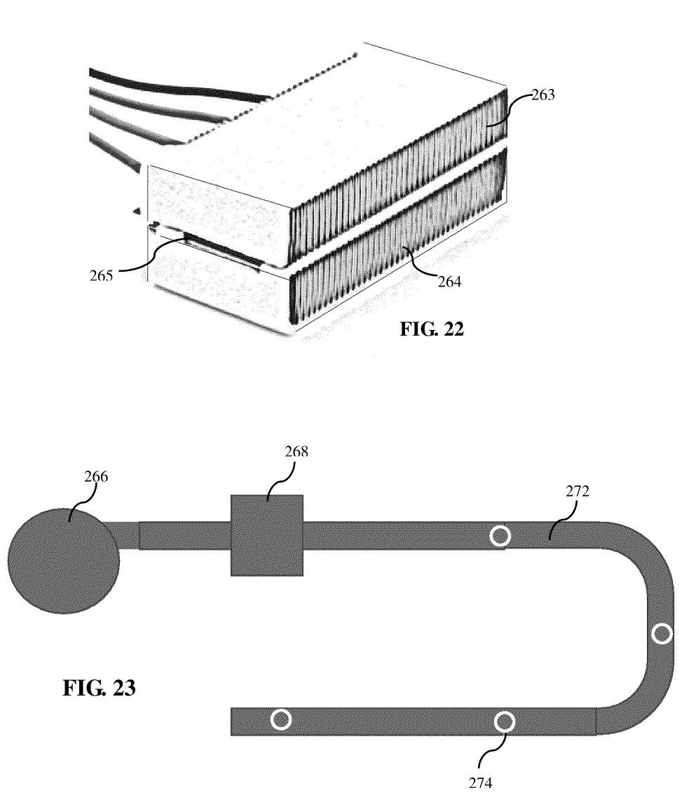

Specifically, FIG. 22 shows the thermoelectric heating and cooling module with heat sinks on both sides. In this aspect, the thermoelectric device assembly consists of a top heat sink 263, a thermoelectric device 265, and a bottom heat sink 264.

FIG. 23 shows a thermoelectric heating and cooling aspect in a general system component layout 23. Air drawn into the blower 266 is forced through the thermoelectric heating and cooling assembly 268, heating or cooling the flowing air and is then distributed through the air distribution tube or duct 272. The cooled or heated air is then distributed to the air distribution exit tubes 274 to the seat surface, cooling or heating the occupant.

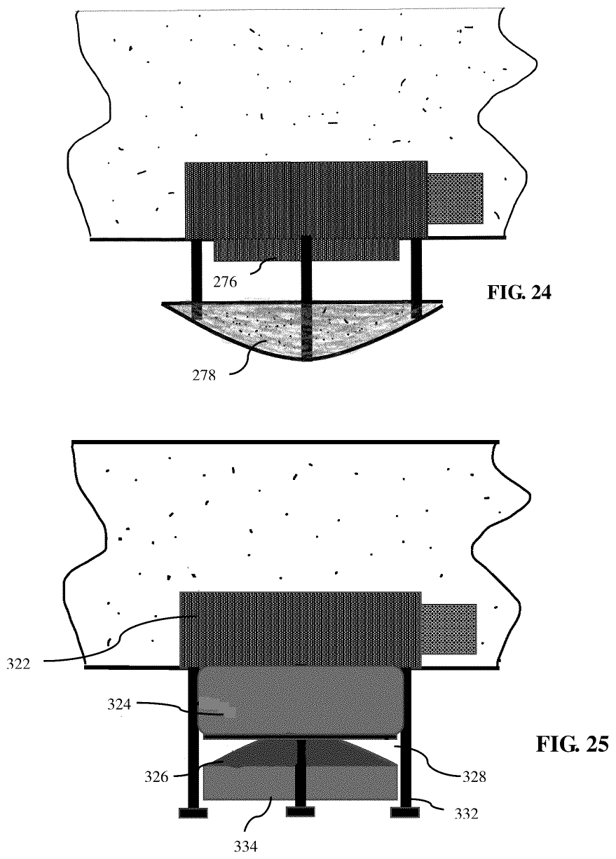

To prevent water from splashing into the seat, FIG. 24 shows my design for a splash guard 278 that helps prevent splashed water from entering the blower intake 276. Frequently, water may come from a water hose used for cleaning the motorcycle or other vehicle. In applications where the blower intake is accessible by fingers, this guard also protects against injury.

Now, we look at FIG. 25 which shows an underwater protection float valve. This aspect includes a float that seals the intake to the blower in the event the vehicle is submerged, such as in off road vehicles, where this can occur. When the water level reaches the float, the buoyant tapered float 334 moves up and seals against the intake of the blower cowling 324, which can be a separate cylindrical member or an extended part of the blower intake, thereby preventing water and/or mud from intruding into blower 322. The upward dome portion of the float 326 can be of elastomeric material to better seal the opening in the cowling of the blower intake. An O-ring seal 328, can also be used on the intake cowling lower ridge, providing a seal. Guide stanchions 332 provide freedom of movement of the float, while guiding the float into proper sealing position during a flotation event. In the open position, air is free to flow into the blower. The domed design of the tapered float provides a low pressure drop intake of air due to the straightening effect of the air impinging upon the angled surface and being directed in a more perpendicular fashion. The design of this float valve can obviously be somewhat altered but maintain the same concept.

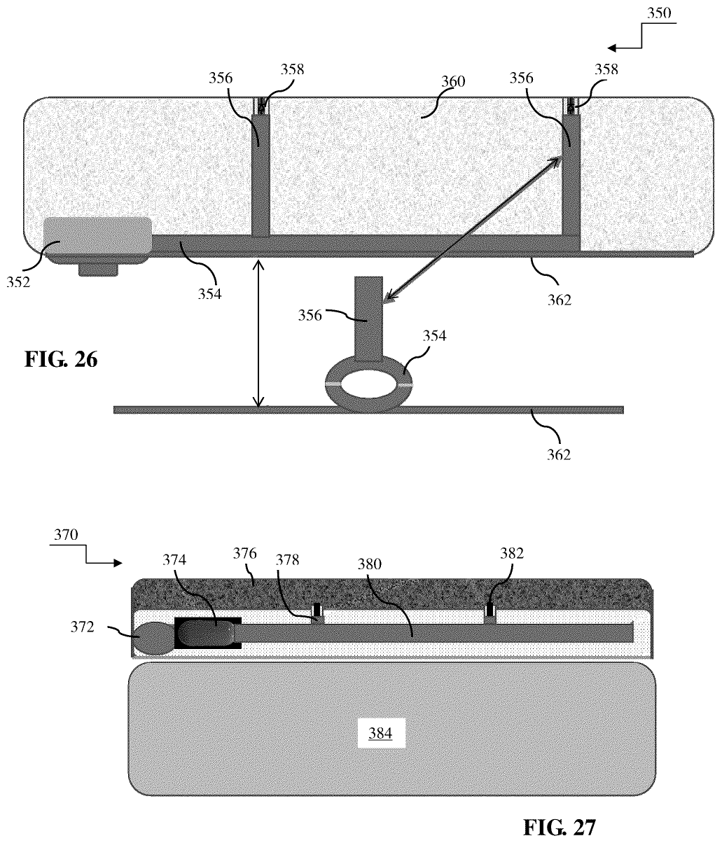

Moving on to FIG. 26, shown is a perforated seat generally denoted by numeral 350. One of the preferred placements of horizontal and vertical air tubes 354 and 356, respectively, is shown. Contained within seat foam 360, air distribution tubes 354 and 356 may be formed in many ways, including bellows, tubing or even cavities formed in the seat foam itself and then coated inside with a sealant on the porous seat foam to make an air tight opening going from blower/heater 352 through air tubes 354 and 356. The air from blower 352 is then urged through one way valves 358 so that no water can come in. A cross section of vertical air tube 356 is shown in air flow communication with horizontal air tube 354, on top of seat pan 362.

FIG. 27 illustrates yet another aspect of the invention which is an aftermarket heated seat pad that can be placed over an original equipment manufacturer's seat 384, providing a way of retroactively providing a heated and/or cooled seat. This accessory pad aspect is generally denoted by numeral 370 and includes a blower 372 which blows air to the occupant through a heater 374 and then through air distribution tubes 380 and then upward through air tubes 378 and one way valves 382, then through the seat foam seat pad material that can be reticulated foam, 3D mesh material or other suitable material 376. However, if the pad is made of reticulated foam for 3D mesh, the air tubes would not be passing through the seat foam 376. The accessory pad may be made of industrial foam, 3D mesh, reticulated foam or any other suitable material. The entire assembly is encased preferably in an air-proof material, including fabric, plastic or rubber on the side and bottom, so that air is captured and forced to move upward to the seat occupant.

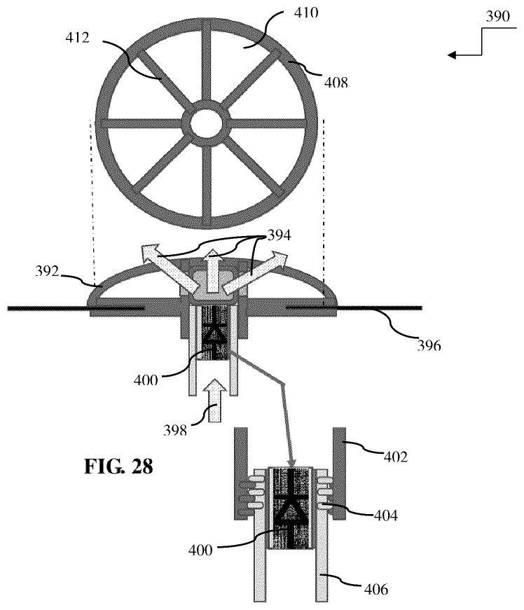

Lastly, FIG. 28. shows a secure way of joining the air outlet feature, shown collectively as numeral 390, to the air tube 402 near the surface of the seat 396. As in other aspects, a one way valve 400 receives air flow 398 and urges air outflow 394 through an air dome 392 through openings 410 between air dome ribs 412. One way valve 400 is secured within air tube 402 by press fitting, screwing in, or any other suitable means. One way valve 400 is secured by housing 406. Air distribution tube 406 can alternately be joined to the air outlet feature opening 402 by the use of interlocking ribs 404 that provide a secure locking mechanism.

Therefore, disclosed is a weather resistant ventilated seat assembly, comprising at least a ventilated seat cushion cover secured over a seat cushion with an air flow distribution system inside. Air ducts inside the seat cushion direct the air being distributed. In order to prevent infiltration of liquids from outside, a plethora of one-way valves direct the conditioned air out of air exits toward the seat occupant. In order to direct the air through exits toward the seat occupant, a blower is included, preferably by a high flow rate, high pressure blower motor. Weather resistant covers over the air ducts help to keep the seat cushion dry even when it rains or the seat is washed. The weather resistant covers preferably include some sort of hydrophilic material, such as a 3D spacer mesh, covering over the air exits.

The weather resistant seat assembly will resist water infiltrating any heating system within the seat to aid a comfortable temperature, such as by including a low-cost resistance heater placed in the airstream within the air flow distribution ducts that are in communication with the blower. In addition, further comfort can be achieved by the use of an in-line desiccant container added to the air flow stream within the air flow distribution ducts. Merely blowing dry air against the bottom of a seat occupant adds comfort.

An alternative aspect for providing heated and cooled air utilizes a thermoelectric device inline upstream from the blower motor, wherein heated and cooled air pass there over, thereby heating and cooling the air which will eventually reach the seat occupant. Perforations in the seat aid to deliver this heated and/or cooled air through perforations in the seat cushion cover to be felt by the seat occupant.

In order to further prevent water from entering the seat through the perforations, a splash guard will be useful to allow for airflow to the blower intake while deflecting splash. Further, a float valve mechanism is also envisioned that blocks ingress by the floating of a low density member into a sealing position of the blower intake.

In summary, numerous benefits have been described which result from employing any or all of the concepts and the features of the various specific aspects of the present invention, or those that are within the scope of the invention. The present invention acts perfectly to prevent water damage from heated and cooled air distribution systems installed in seats and other surfaces subjected to rain, snow and the outer elements.

The foregoing description of several levels of preferred aspects of the invention have been presented for purposes of illustration and description. It is not intended to be to be exhaustive or to limit the invention to the precise form disclosed. Obvious modifications or variations are possible in light of the above teachings with regards to the specific aspects. The various aspects were chosen and described in order to best illustrate the principles of the invention and its practical applications to thereby enable one of ordinary skill in the art to best utilize the invention in various aspects and with various modifications as are suited to the particular use contemplated. It is intended that the scope of the invention be defined by the claims which are appended hereto.

### INDUSTRIAL APPLICABILITY

The present invention finds utility in the outdoor heated seat industry, finding particular utility for heated motorcycle and agricultural seating markets, among others.

What is claimed is:

1. A weather resistant ventilated seat assembly, comprising;
a ventilated seat cushion cover;
a seat cushion;
an air flow distribution system including air ducts and air exits inside the seat cushion to direct an airstream directed toward the seat occupant;
at least one one-way valve in the air exits directing the airstream toward the seat occupant;
a blower including an airflow intake moved by a high flow rate, high pressure blower motor; and
weather resistant covers over the air ducts.

2. The weather resistant seat assembly of claim 1, wherein the weather resistant covers include hydrophilic 3D spacer mesh covers over the air exits.

3. The weather resistant seat assembly of claim 1, further comprising a heating system including a low-cost resistance heater placed in the airstream within the air flow distribution ducts that are in communication with the blower.

4. The weather resistant seat assembly of claim 1, further comprising a desiccant container added to the air flow distribution ducts to dry the airstream passing within.

5. The weather resistant seat assembly of claim 1, further comprising an inline thermoelectric device upstream from the blower motor, wherein heated and cooled air pass there over, thereby heating and cooling conditioning the airstream which will eventually reach the seat occupant.

6. The weather resistant seat assembly of claim 1, further comprising a splash guard to allow for airflow to the blower intake while deflecting splash.

7. The weather resistant seat assembly of claim 1, further comprising a float valve mechanism that blocks ingress of liquids by the floating of a low density member into a sealing position of the blower intake.
